(19) United States
(12) Patent Application Publication
(10) Pub. No.: US 2012/0155810 A1
(43) Pub. Date: Jun. 21, 2012

(54) DUPLEX OPTICAL CONNECTOR

(76) Inventor: Masaya NAKAGAWA, Kyoto-shi (JP)

(21) Appl. No.: 13/315,499

(22) Filed: Dec. 9, 2011

(30) Foreign Application Priority Data
Dec. 17, 2010 (JP) 2010-281887

(51) Int. Cl. G02B 6/36

(52) U.S. Cl. 385/78

(57) ABSTRACT

Provided is a duplex optical connector in which a pair of connector mounting portions of a holder includes a first abutment portion (first cylindrical surface) abuttable against a groove bottom surface of an annular groove provided at a proximal end of corresponding one of a pair of optical connectors from one side in a width direction, a second abutment portion (second cylindrical surface) abuttable against the groove bottom surface from another side in the width direction, and a widthwise movable region (W) which allows the corresponding one of the pair of optical connectors to move in the width direction between the first abutment portion and the second abutment portion with respect to the holder. With this, a pitch between the pair of optical connectors can be changed.

### TECHNICAL FIELD

The present invention relates to a duplex optical connector, which is used mainly for bidirectional communication.

### BACKGROUND ART

For example, Patent Literature 1 discloses a duplex optical connector for bidirectional communication. Specifically, Patent Literature 1 discloses a duplex optical connector including a pair of optical connectors each including a ferrule having an inner periphery on which an optical fiber is passed and a housing for holding the ferrule, and a holder for holding the pair of optical connectors in array with a predetermined widthwise gap.

### CITATION LIST

Patent Literature 1: JP 2005-189288 A

### SUMMARY OF INVENTION

### Technical Problem

In the duplex optical connector, a pitch between the pair of optical connectors (widthwise gap), specifically, a pitch between the pair of optical fibers is determined by a standard (for example, as for LC type, 6.25 mm). A pitch between mounting holes of a multicore optical adapter (for example, optical transceiver) to which such a duplex optical connector is to be mounted is similarly determined by a standard. Thus, in the above-mentioned duplex optical connector, the pair of optical connectors are fixed to the holder at a pitch determined by a standard. Specifically, as illustrated in FIG. 13, a groove bottom surface 120 (indicated by a chain line) of an annular groove provided at a proximal end portion of each of the pair of optical connectors is fixed to corresponding one of connector mounting portions 111 provided to a holder 110 in a state of being regulated in movement in a width direction (lateral direction in FIG. 13). Specifically, by holding a region of more than 180° (region C in FIG. 13) of cylindrical outer peripheral surfaces 120 of the optical connectors by the connector mounting portions 111 of the holder 110, movement of the optical connectors to both sides in the width direction is regulated.

By the way, recently, in accordance with a trend of space saving of optical communication devices such as an optical server, there has been growing a demand for downsizing of an optical adapter as a connection terminal. In order to meet the demand, optical adapters having mounting holes with a pitch smaller than standards have started to become available. In order to mount duplex optical connectors to such optical adapters with a small pitch, duplex optical connectors having a pitch set in accordance with the pitch of the optical adapters are required. Thus, for example, when a plurality of types of optical adapters each having a different pitch are provided to an optical server, it is necessary to prepare a plurality of types of duplex optical connectors each having a different pitch set in accordance therewith, which leads to a cost increase. Further, it is also necessary to selectively mount the duplex optical connectors corresponding respectively to the pitches of the optical adapters, which leads to deterioration in mounting operability.

The present invention has been made to achieve an object of providing a duplex optical connector that can be mounted to multicore optical adapters each having a different pitch without involving a cost increase and deterioration in mounting operability.

### Solution to Problem

In order to achieve the above-mentioned object, the present invention provides a duplex optical connector, including: a pair of optical connectors each including a ferrule provided with an insertion hole for an optical fiber; and a holder including a pair of connector mounting portions for holding the pair of optical connectors in parallel array in a state of being separated from each other in a width direction, in which the pair of connector mounting portions each includes: a first abutment portion abuttable against corresponding one of the pair of optical connectors from one side in the width direction; a second abutment portion abuttable against the corresponding one of the pair of optical connectors from another side in the width direction; and a widthwise movable region which allows the corresponding one of the pair of optical connectors to move in the width direction between the first abutment portion and the second abutment portion with respect to the holder.

As described above, in the duplex optical connector according to the present invention, the pair of optical connectors are allowed to move in the width direction with respect to the holder. With this, a pitch between the pair of optical connectors can be changed. According to the duplex optical connector, the pair of optical connectors can be mounted to an optical adapter by changing the pitch between the pair of optical connectors in accordance with a pitch of the optical adapter. With this, cost reduction is achieved because it suffices that a single type of a duplex optical connector is prepared with respect to a plurality of types of optical adapters each having a different pitch. Further, an operation of selecting a duplex optical connector corresponding to a pitch of the optical adapter is no longer necessary, and hence mounting operability is enhanced. Note that, the “width direction” represents a direction of the pitch between the pair of optical connectors, in other words, a direction orthogonal to central axes of the ferrules of the pair of optical connectors on a plane including the central axes.

### Advantageous Effects of Invention

As described above, a single type of a duplex optical connector according to the present invention can support a plurality of types of multicore optical adapters each having a different pitch. Thus, cost reduction can be achieved and mounting operability can be enhanced.

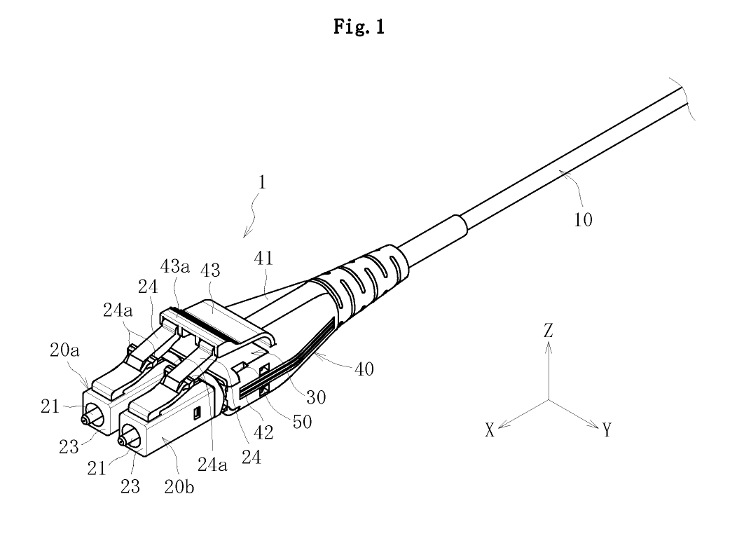

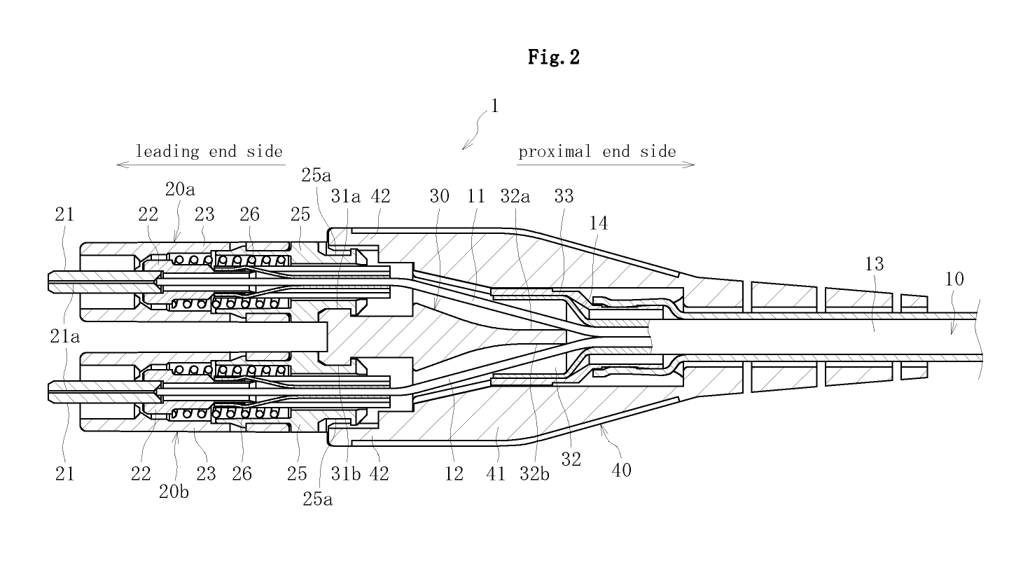

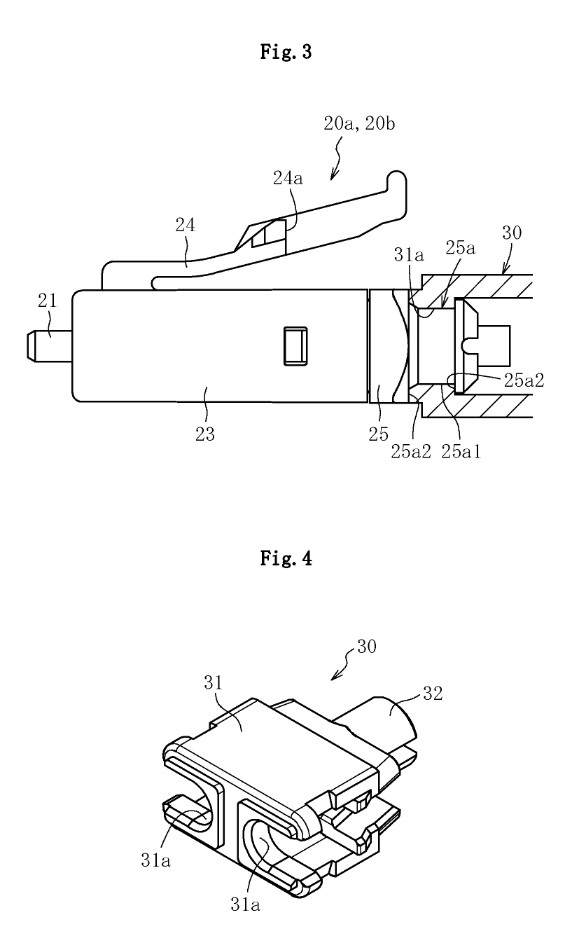

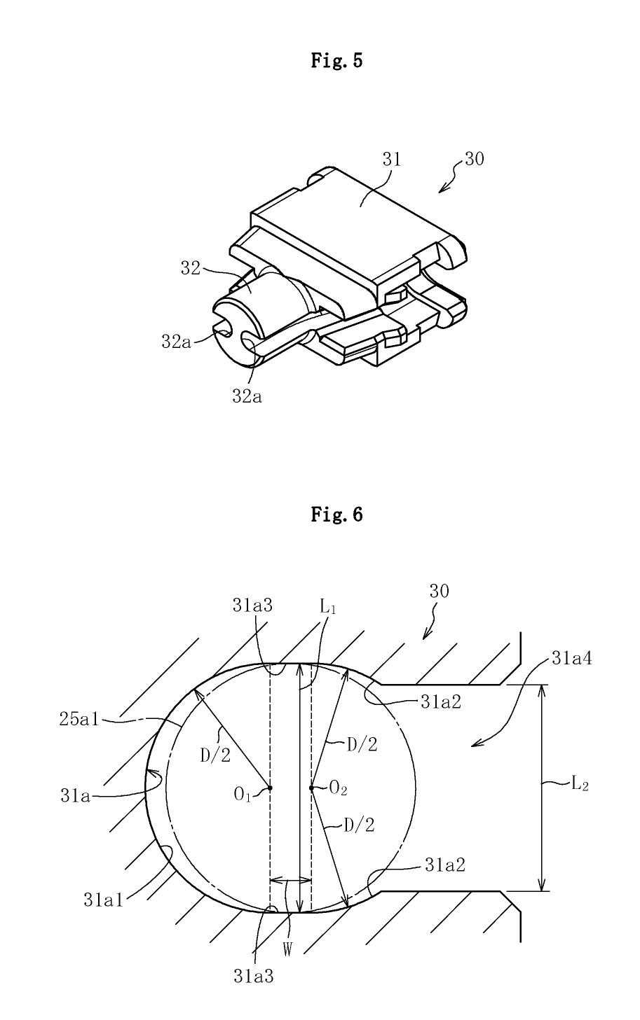

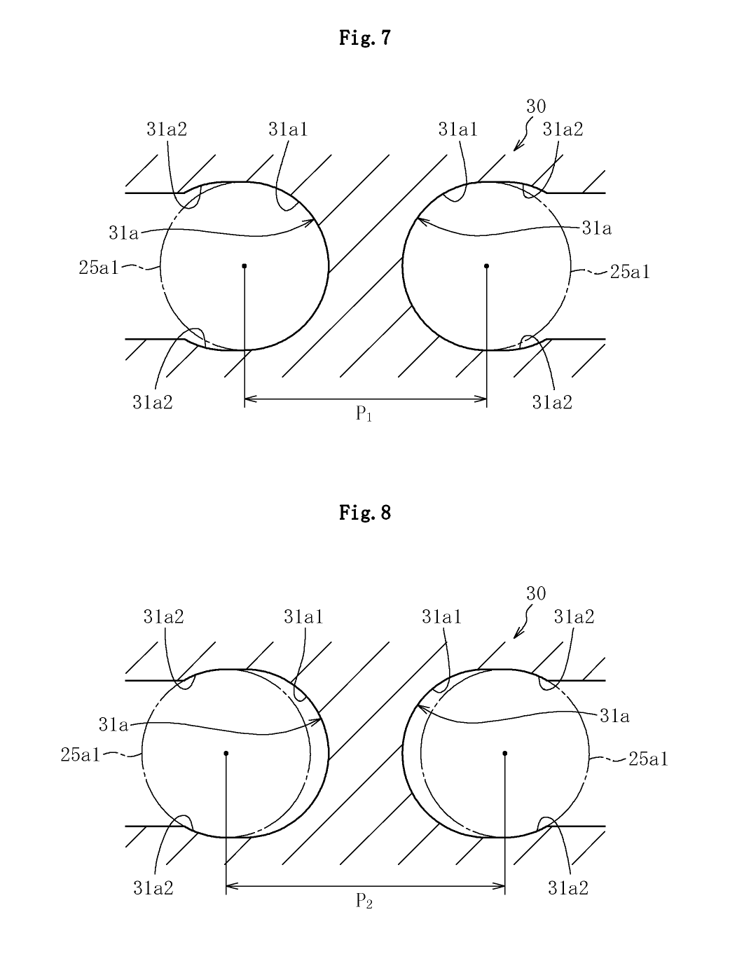

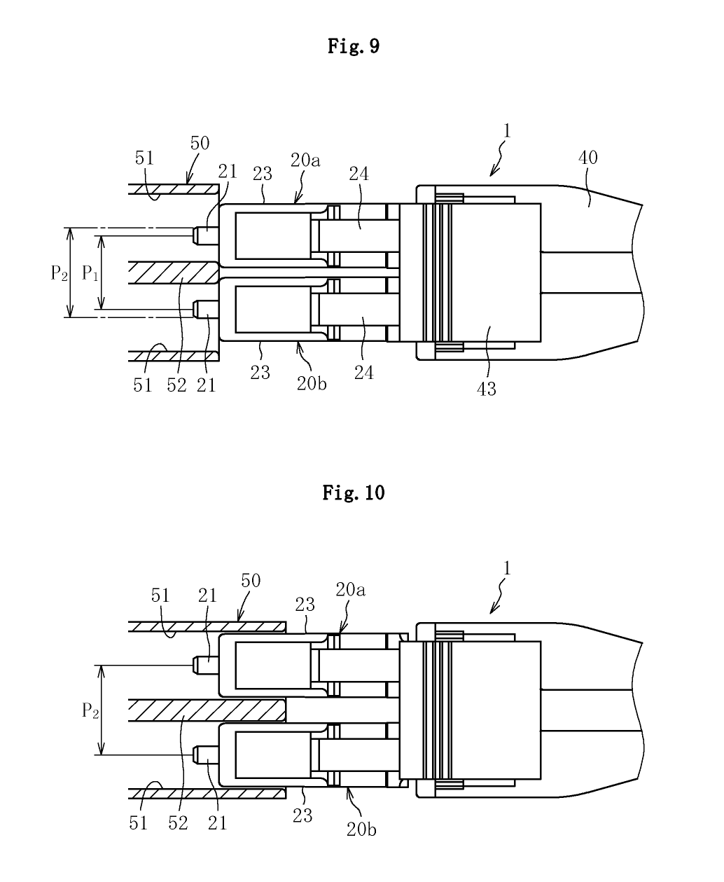

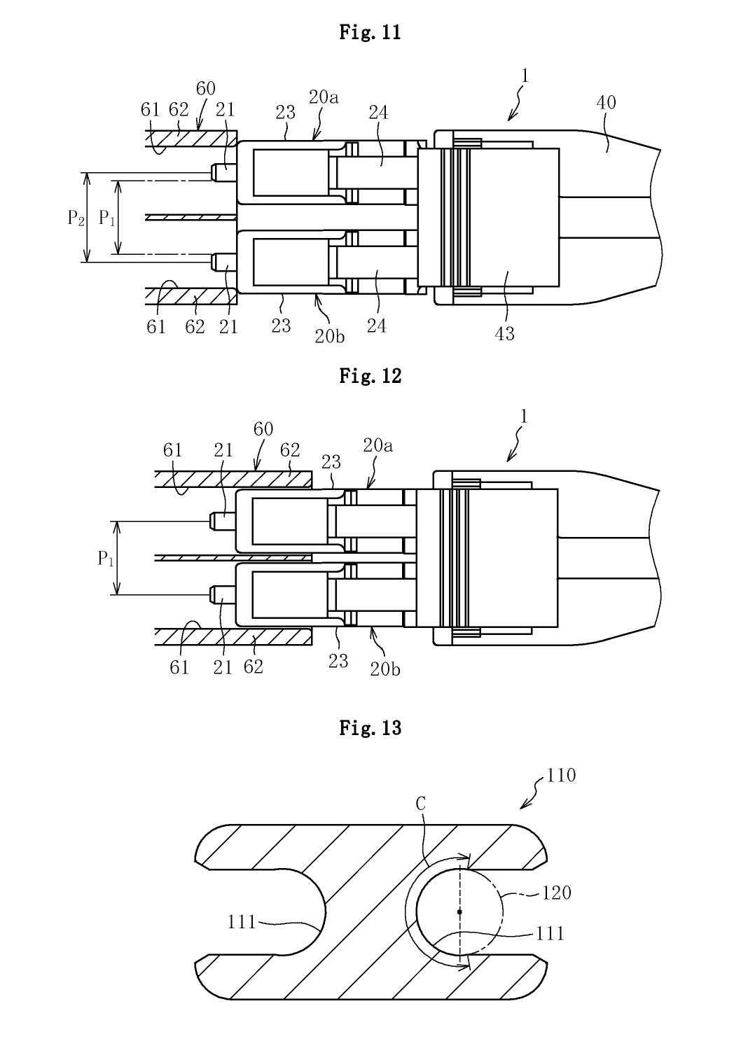

### BRIEF DESCRIPTION OF DRAWINGS

[FIG. 1] A perspective view of a duplex optical connector according to an embodiment of the present invention.

[FIG. 2] A sectional view of the duplex optical connector.

[FIG. 3] A side view of an optical connector to be incorporated in the duplex optical connector and sectional view of a holder.

[FIG. 4] A perspective view of the holder.

[FIG. 5] Another perspective view of the holder.

[FIG. 6] A partial sectional view of the holder.

[FIG. 7] A sectional view of the holder (in a state of a minimum pitch P₁).

[FIG. 8] A sectional view of the holder (in a state of a maximum pitch P₂).

[FIG. 9] A plan view illustrating a state in which the duplex optical connector is mounted to an optical adapter with the pitch P₂.

[FIG. 10] Another plan view illustrating the state in which the duplex optical connector is mounted to the optical adapter with the pitch P₂.

[FIG. 11] A plan view illustrating a state in which the duplex optical connector is mounted to an optical adapter with the pitch P₁.

[FIG. 12] Another plan view illustrating the state in which the duplex optical connector is mounted to the optical adapter with the pitch P₁.

[FIG. 13] A sectional view of a holder for a conventional duplex optical connector.

### DESCRIPTION OF EMBODIMENT

In the following, description is made of an embodiment of the present invention with reference to the drawings.

A duplex optical connector 1 according to the embodiment of the present invention is mounted to a multicore optical adapter (not shown) (for example, optical transceiver). As illustrated in FIG. 1, the duplex optical connector 1 mainly includes an input optical connector 20a, an output optical connector 20b, a holder 30 for holding the optical connectors 20a and 20b, and a boot 40. Note that, in the following, for the sake of convenience in description, a central axis direction of a ferrule 21 provided in each of the optical connectors 20a and 20b (X direction in FIG. 1 and lateral direction in FIG. 2) is referred to as an “optical axis direction,” a direction along a pitch between the pair of optical connectors 20a and 20b (Y direction in FIG. 1 and vertical direction in FIG. 2) is referred to as a “width direction,” and a direction orthogonal to the optical axis direction and the width direction (Z direction in FIG. 1 and direction orthogonal to the drawing sheet of FIG. 2) is referred to as a “vertical direction.” Further, the optical adapter side in the optical axis direction (left side of FIG. 2) is referred to as a leading end side, and the opposite side thereof (right side of FIG. 2) is referred to as a proximal end side.

As illustrated in FIG. 2, the duplex optical connector 1 is mounted to a leading end of a duplex cable 10. The duplex cable 10 includes a pair of bare fibers 11 and 12, a covering tube 13, and a reinforcement fiber 14. Each of the bare fibers 11 and 12 has an optical fiber incorporated therein. The covering tube 13 covers an outer periphery of the pair of bare fibers 11 and 12 and collectively holding the same. The reinforcement fiber 14 is filled between the bare fibers 11 and 12 and the covering tube 13.

The input optical connector 20a and the output optical connector 20b are both an LC type optical connector and have a similar configuration. As illustrated in FIGS. 2 and 3, the optical connectors 20a and 20b each mainly include the ferrule 21 fixed to the leading end of corresponding one of the bare fibers 11 and 12, a flange part 22 fixed at a proximal end portion of the ferrule 21, a housing 23 holding the ferrule 21 within its inner periphery, a locking lever 24 provided in a top surface of the housing 23, and a cap 25 provided in a proximal end portion of the housing 23.

The housing 23 has a through-hole in the optical axis direction as illustrated in FIG. 2. The through-hole accommodates the ferrule 21, the flange part 22, a spring 26, and corresponding one of the bare fibers 11 and 12. The ferrule 21 has an insertion hole 21a into which an optical fiber (not shown) is passed. The spring 26 is mounted in a compressed state in the optical axis direction between the flange part 22 and the cap 25. The spring 26 applies an elastic force to urge the ferrule 21 to the leading end side. As illustrated in FIG. 3, the cap 25 has an annular groove 25a formed continuously over the entire periphery. The annular groove 25a has a groove bottom surface 25a1 having a shape of a cylindrical surface and side surfaces 25a2 rising radially outward from a leading end and a proximal end of the groove bottom surface 25a1.

As illustrated in FIG. 3, the locking lever 24 extends obliquely upward from the top surface of the housing 23 toward the proximal end side and is elastic in the vertical direction. In this embodiment, the locking lever 24 and the housing 23 are integrally molded with a resin. The locking lever 24 includes an interlocking portion 24a in its middle portion. The interlocking portion 24a is engaged, in the optical axis direction, with a locking groove (not shown) provided in the optical adapter, to thereby prevent the optical connector 20a or 20b from coming off the optical adapter.

As illustrated in FIGS. 4 and 5, the holder 30 has a symmetrical shape in the vertical direction and the lateral direction, and includes a main body portion 31 and a cable fixing portion 32 projecting from the main body portion 31 to the proximal end side. At a leading end of the main body portion 31 of the holder 30, there is provided a pair of connector mounting portions 31a for holding the optical connectors 20a and 20b in parallel array in a state of being separated from each other in a width direction (refer to FIG. 4). As illustrated in FIG. 3, the connector mounting portions 31a fit respectively to the annular grooves 25a of the caps 25 of the optical connectors 20a and 20b. With this, the connector mounting portion 31a and both the side surfaces 25a2 of the annular groove 25a are engaged with each other on both sides in the optical axis direction. In this way, the optical connectors 20a and 20b are positioned with respect to the holder 30 in the optical axis direction. Note that, the shape of the holder 30 is not limited to the symmetrical shape as described above. For example, an operation lever (described in detail below), which is provided to the boot 40 in this embodiment, may be provided to the holder, in other words, the holder may be formed into a vertically asymmetrical shape.

As illustrated in FIG. 6, the connector mounting portion 31a includes a first abutment portion abuttable against corresponding one of the optical connectors 20a and 20b (specifically, groove bottom surface 25a1 of the annular groove 25a of the cap 25) from a widthwise center side (left side of FIG. 6), a second abutment portion abuttable against the corresponding one of the optical connectors 20a and 20b from a widthwise outer side (right side of FIG. 6), and a widthwise movable region W provided between the first abutment portion and the second abutment portion. In this embodiment, a first cylindrical surface 31a1 having a shape of a semi-cylindrical surface is provided as the first abutment portion, and second cylindrical surfaces 31a2 each having a shape of a partially cylindrical surface are provided as the second abutment portion at two points vertically separated from each other. A center O₂ of the second cylindrical surfaces 31a2 is offset to a widthwise outer side with respect to a center O₁ of the first cylindrical surface 31a1.

The widthwise movable region W is a region in which the corresponding one of the optical connectors 20a and 20b is movable in the width direction between the first abutment portion and the second abutment portion. In the illustration, the widthwise movable region W is formed of a pair of parallel flat surfaces 31a3 smoothly continuous with the first cylindrical surface 31a1 and the second cylindrical surfaces 31a2 and separated from each other in the vertical direction. The connector mounting portion 31a is formed by opening a side surface on the widthwise outer side of the holder 30. In the illustration, an opening portion 31a4 formed of a pair of flat surfaces is formed on a widthwise outer side of the second cylindrical surfaces 31a2. A diameter D of the first cylindrical surface 31a1 and the second cylindrical surfaces 31a2, and a vertical gap L₁ between the pair of flat surfaces 31a3 are equal to or somewhat larger than an outer diameter of the groove bottom surface 25a1 of the annular groove 25a. A vertical dimension L₂ of the opening portion 31a4 is somewhat smaller than the outer diameter of the groove bottom surface 25a1 of the annular groove 25a.

The optical connectors 20a and 20b are mounted to the holder 30 as follows. First, the groove bottom surface 25a1 of the annular groove 25a of each of the optical connectors 20a and 20b is pushed into the opening portion 31a4 of the holder 30 from the widthwise outer side so that the pair of vertical flat surfaces forming the opening portion 31a4 is elastically and vertically expanded. After a center of the groove bottom surface 25a1 has passed the opening portion 31a4, the opening portion 31a4 elastically restores, and the groove bottom surface 25a1 is accommodated in the connector mounting portion 31a. In this way, mounting of the optical connectors 20a and 20b is completed.

Each of the optical connectors 20a and 20b respectively accommodated in the connector mounting portions 31a is allowed to move widthwise with respect to the holder 30 as long as the center of the groove bottom surface 25a1 of the annular groove 25adoes not move out of the widthwise movable region W. Thus, the optical connectors 20a and 20b are allowed to move widthwise with respect to the holder 30 by an amount corresponding to a widthwise distance between the center O₁ of the first cylindrical surface 31a1 and the center O₂ of the second cylindrical surfaces 31a2, in other words, by an amount corresponding to a widthwise length of the flat surfaces 31a3. In particular, by setting the vertical gap L₁ between the pair of flat surfaces 31a3 to be equal to or somewhat larger than the outer diameter of the annular groove 25a of each of the optical connectors 20a and 20b, the optical connectors 20a and 20b are allowed to smoothly and freely move widthwise. For example, when the widthwise distance between the center O₁ of the first cylindrical surface 31a1 and the center O₂ of the second cylindrical surfaces 31a2 is set to 0.5 mm in each of the connector mounting portions 31a, a variable amount of the pitch between the optical connectors 20a and 20b is set to 1 mm.

The cable fixing portion 32 of the holder 30 has a substantially columnar shape, and includes a pair of guide grooves 32a formed on its sides in the width direction, for guiding the bare fibers 11 and 12 (see FIG. 5). The pair of guide grooves 32a are curved outward in the width direction so as to extend away from each other toward the leading end side and extend into the main body portion 31 (see FIG. 2).

As illustrated in FIG. 2, the bare fibers 11 and 12 are respectively accommodated in the guide grooves 32a formed in the cable fixing portion 32 of the holder 30. The outer periphery of the cable fixing portion 32 is covered by the reinforcement fiber 14. A cylindrical caulking member 33 is mounted over the outer periphery of the cable fixing portion 32 and the reinforcement fiber 14, and the outer periphery of the caulking member 33 is fixedly caulked, thereby fixing the duplex cable 10 to the holder 30.

The boot 40 is formed of a flexible material (for example, elastomer), and, as illustrated in FIG. 1, the boot 40 integrally includes a main body portion 41, a pair of fixing portions 42 which extend from both widthwise end portions of the main body portion 41 to the leading end side to be fixed to the holder 30, and an operation lever 43 which is provided in a top surface of the main body portion 41. As illustrated in FIG. 2, the main body portion 41 covers the outer periphery of the duplex cable 10 extending from the cable fixing portion 32 of the holder 30 to the proximal end side.

As illustrated in FIG. 1, the operation lever 43 extends obliquely upward from the top surface of the main body portion 41 toward the leading end side. The operation lever 43 includes a leading end portion which is provided above proximal end portions of the locking levers 24 of the pair of optical connectors 20a and 20b. When the operation lever 43 is downwardly pressed to be elastically deformed, a leading end portion 43a of the operation lever 43 downwardly presses the proximal end portions of the pair of locking levers 24 altogether, to thereby elastically deform the locking levers 24. This causes the interlocking portions 24a of the locking levers 24 to be disengaged from the locking groove (not shown) of the optical adapter, with the result that the duplex optical connector 1 can be removed from the optical adapter.

In the duplex optical connector 1 structured as described above, the pitch between the optical connectors 20a and 20b can be changed in accordance with a pitch between mounting holes of the optical adapter. For example, as illustrated in FIG. 7, when the groove bottom surface 25a1 of the annular groove 25a provided at a proximal end portion of each of the optical connectors 20a and 20b abuts against the first cylindrical surface 31a1 of each of the connector mounting portions 31a of the holder 30, the pitch between the optical connectors 20a and 20b is a minimum P₁. Meanwhile, as illustrated in FIG. 8, when the groove bottom surface 25a1 of the annular groove 25a of each of the optical connectors 20a and 20b abuts against the second cylindrical surfaces 31a2 of each of the connector mounting portions 31a of the holder 30, the pitch between the optical connectors 20a and 20b is a maximum P₂.

For example, as illustrated in FIG. 9, when the duplex optical connector 1 having the optical connectors 20a and 20b with a pitch of P₁ is mounted to an optical adapter 50 having a pair of mounting holes 51 with a center-to-center pitch of P₂, a leading end of the housing 23 of each of the optical connectors 20a and 20b abuts against a central wall 52 of the optical adapter 50. Thus, the central wall 52 is inserted between the pair of housings 23, with the result that the pitch between the optical connectors 20a and 20b is increased to P₂. In this way, as illustrated in FIG. 10, the optical connectors 20a and 20b are respectively inserted into the mounting holes 51.

Note that, as illustrated in FIG. 9, when the duplex optical connector 1 with the minimum pitch P₁ is inserted into the mounting holes 51 with the maximum pitch P₂, a leading end surface of the housing 23 of each of the optical connectors 20a and 20b may interfere with an end surface of the central wall 52 of the optical adapter 50 in some cases. In this case, round portions (curved surface portions) provided at corners of both widthwise ends of the leading end surface of each of the housings 23 and round portions provided at corners of both widthwise ends of the end surfaces of the central wall 52 abut against each other. With this, the optical connectors 20a and 20b are guided to the widthwise outer side. As a result, the pair of optical connectors 20a and 20b are inserted into the pair of mounting holes 51 of the optical adapter 50.

Further, the connector mounting portions 31a of the holder 30 do not regulate the widthwise movement of the optical connectors 20a and 20b in the widthwise movable region W. Thus, by guiding with use of the round portions as described above, the optical connectors 20a and 20b are allowed to easily move widthwise with respect to the holder 30, and the pitch between the optical connectors 20a and 20b can be easily changed. Further, the optical connectors 20a and 20b of the duplex optical connector 1 are not always held at the minimum pitch P₁ before being mounted to the optical adapter, and hence the optical connectors 20a and 20b are normally held at a pitch somewhat larger than the minimum pitch P₁ illustrated in FIG. 9. Thus, actually, the leading end surfaces of each of the housings 23 and the end surfaces of the central wall 52 of the optical adapter 50 scarcely interfere with each other. Thus, the pair of optical connectors 20a and 20b can be smoothly inserted into the pair of mounting holes 51 of the optical adapter 50.

Conversely to the above-mentioned case, FIGS. 11 and 12 illustrate a case where the duplex optical connector 1 having the optical connectors 20a and 20b with a pitch of P₂ is mounted to an optical adapter 60 having a pair of mounting holes 61 with a center-to-center pitch of P₁. In this case, the round portions provided at the corners of both widthwise ends of the leading end surface of each of the housings 23 and side walls 62 at both widthwise ends of the optical adapter 60, specifically, round portions provided at corners on a widthwise inner side of end surfaces of the side walls 62 are brought into abutment with each other. With this, the optical connectors 20a and 20b are guided to the widthwise inner side (refer to FIG. 11). In this way, the optical connectors 20a and 20b are inserted into the pair of mounting holes 61 of the optical adapter 60, with the pitch between the optical connectors 20a and 20b being reduced to P₁ (refer to FIG. 12).

The present invention is not limited to the above-mentioned embodiment. For example, in the above-mentioned embodiment, each of the first abutment portion and the second abutment portion is formed of a cylindrical surface. However, the present invention is not limited thereto, and any form is applicable as long as the first abutment portion and the second abutment portion abut against the optical connectors 20a and 20b in the width direction and regulate the widthwise movement of the same. For example, each of the first abutment portion and the second abutment portion may be formed of a flat surface.

Further, in the above-mentioned embodiment, the widthwise movable region W is provided in each of the pair of connector mounting portions 31a. However, the present invention is not limited thereto. For example, the widthwise movement of only one of the optical connectors may be regulated in one of the connector mounting portions, and the widthwise movable region W may be provided only for another of the optical connectors.

### REFERENCE SIGNS LIST

1 duplex optical connector
10 duplex cable
20a (input) optical connector
20b (output) optical connector
21 ferrule
21a insertion hole
22 flange part
23 housing
24 locking lever
25 cap
25a annular groove
25a1 groove bottom surface
25a2 side surface
26 spring
30 holder
31 main body portion
31a connector mounting portion
31a1 first cylindrical surface (first abutment portion)
31a2 second cylindrical surface (second abutment portion)
31a3 flat surface
31a4 opening portion
32 cable fixing portion
40 boot
W widthwise movable region

1. A duplex optical connector, comprising:
a pair of optical connectors each comprising a ferrule provided with an insertion hole for an optical fiber; and
a holder comprising a pair of connector mounting portions for holding the pair of optical connectors in parallel array in a state of being separated from each other in a width direction,
wherein the pair of connector mounting portions each comprises:
a first abutment portion abuttable against corresponding one of the pair of optical connectors from one side in the width direction;
a second abutment portion abuttable against the corresponding one of the pair of optical connectors from another side in the width direction; and
a widthwise movable region which allows the corresponding one of the pair of optical connectors to move in the width direction between the first abutment portion and the second abutment portion with respect to the holder.
